(19) United States
(12) Patent Application Publication
(10) Pub. No.: US 2024/0254702 A1
(43) Pub. Date: Aug. 1, 2024

(54) Automated Painting System

(71) Applicant: Robert E Morrison, Yorkton (CA)

(72) Inventor: Robert E Morrison, Yorkton (CA)

(21) Appl. No.: 18/101,650

(22) Filed: Jan. 26, 2023

(51) Int. Cl. E01C 23/22; B05B 12/16; B05B 12/36; B05B 13/00; B05B 15/68

(52) U.S. Cl. CPC E01C 23/222; B05B 12/16; B05B 12/36; B05B 13/005; B05B 15/68

(57) ABSTRACT

An automated system for painting a programmed design on high-traffic surfaces. The system includes a transportable housing having a compartment for holding paint and a spraying mechanism for spraying the paint via a spray head that is movable about a plurality of axes. An arm extends from a side of the housing and is connected to the spraying mechanism to provide motion control of the spray head for executing the design. The programmed design is communicated to an onboard control as a grid pattern having an array of uniform blocks aligned in rows and columns. The onboard control paints the design onto a surface by causing the arm and housing to move along the grid pattern to avoid the housing moving through wet paint. The automated system provides an efficient and safe path to paint roadways, parking lots, and the like without having to endanger an operator or passing drivers.

### BACKGROUND OF THE INVENTION

The present invention relates to automated systems. The present invention further provides an automated system for painting a programmed design onto a surface by having an onboard control receive the design as a grid pattern that includes a series of uniform blocks aligned in rows and columns. The onboard control instructs the design to be painted by causing an arm secured to a housing to move along the grid pattern to avoid the housing moving through wet paint.

Painting roadways and parking lots is a necessary task to ensure safety and visibility for drivers and pedestrians. However, the current method of using workers to manually paint these surfaces has several safety and efficiency issues. Workers are at risk of injury from traffic and exposure to harmful chemicals. Additionally, manual painting is time-consuming and labor-intensive, which can lead to delays and increased costs.

There exist robotic devices that are used to mow grass and paint lines on grass fields. However, these devices are not equipped to safely operate in high traffic areas, which limits their usefulness in many situations. The current technology also does not have the capability to paint 3D objects or to have multiple paint attachments for using multiple colors in a single design. This presents a significant problem for painting in high traffic areas and for creating more complex designs. The lack of safety features in existing robotic devices makes it difficult to use them in areas with a high volume of vehicles and pedestrians. Additionally, the inability to paint 3D objects and to use multiple colors in a single design limits the artistic and functional possibilities of current robotic painting technology. Therefore, there exists a need for an automated painting system equipped with the ability to safely operate in high traffic areas and having a multi-axis arm for painting 3D objects and multiple paint attachments for using multiple colors. The automated painting system would be equipped with advanced sensors and navigation systems, allowing them to operate autonomously and reduce the risk of injury to workers. They would also be able to cover large areas quickly and with greater precision, resulting in a higher quality finish and reduced costs. Overall, the use of an unmanned vehicle for road and parking lot painting would greatly improve safety and efficiency in this important task.

In light of the devices disclosed in the known art, it is submitted that the present invention substantially diverges in design elements and methods from the known art and consequently it is clear that there is a need in the art for an improvement for an automated painting system. In this regard the instant invention substantially fulfills these needs.

### SUMMARY OF THE INVENTION

In view of the foregoing disadvantages inherent in the known types of automated painting systems now present in the known art, the present invention provides a new automated painting system wherein the same can be utilized for rapidly and efficiently painting designs on roadways, parking lots, and the like while avoiding reverse travel over wet paint of the newly painted areas.

It is an objective of the present invention to provide an embodiment of an automated painting system comprising a housing having a driving system configured to propel the housing in a front and back direction. The housing further comprises a paint compartment and a spraying mechanism operably connected to the compartment. The spraying mechanism comprises a spray head configured to move about a plurality of axes for painting 3D objects. An arm extends from a side of the housing connected to the spraying mechanism to provide motion control for executing a preprogrammed design that is downloadable to an onboard control.

It is another objective of the present invention to provide an embodiment of an automated painting system wherein the programmed design is communicated to the onboard control as a grid pattern having a series of uniform blocks aligned in rows and columns. The onboard control paints the design onto a surface by causing the arm and housing to move along the grid pattern to avoid the housing moving through wet paint.

It is another objective of the present invention to provide an embodiment of an automated painting system configured to reduce the risk of injury to workers by using an unmanned vehicle for painting and increase painting precision and quality of finished surface by using advanced sensors and navigation systems.

It is another objective of the present invention to provide an embodiment of an automated painting system configured to cover large areas quickly and with greater precision, resulting in reduced costs and to enable the painting of 3D objects and the use of multiple colors in a single design.

It is yet another objective of the present invention to provide an embodiment of an automated painting system configured to increase the artistic and functional possibilities of current robotic painting technology by enabling the use of multiple paint compartments and the use of the spray head for executing the design via a multi-axis arm extending from the housing.

It is yet another objective of the present invention to provide an embodiment of an automated painting system wherein the designs are executed by the arm using geometry code (G-code) to create a grid pattern from the preprogrammed with series of uniform blocks aligned in rows and columns.

It is therefore an object of the present invention to provide a new and improved automated painting device that has all of the advantages of the known art and none of the disadvantages.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

Reference will now be made in detail to the exemplary embodiment (s) of the invention. References to “one embodiment,” “at least one embodiment,” “an embodiment,” “one example,” “an example,” “for example,” and so on indicate that the embodiment(s) or example(s) may include a feature, structure, characteristic, property, element, or limitation but that not every embodiment or example necessarily includes that feature, structure, characteristic, property, element, or limitation. Further, repeated use of the phrase “in an embodiment” does not necessarily refer to the same embodiment.

As used herein, “computer-readable medium” or “memory” excludes any transitory signals, but includes any non-transitory data storage circuitry, e.g., buffers, cache, and queues, within transceivers of transitory signals. As used herein, “logic” refers to (i) logic implemented as computer instructions and/or data within one or more computer processes and/or (ii) logic implemented in electronic circuitry.

FIG. 1 shows a side view of an embodiment of the automated painting system.

FIG. 2 shows a front view of an embodiment of the automated painting system.

FIG. 3 shows a side view of a multi-spray head of an embodiment of the automated painting system.

FIG. 4 shows a block diagram of an embodiment of the automated painting system.

FIG. 5 shows a top planar view of a travel path and design painted onto a surface by an embodiment of the automated painting system.

FIG. 6 shows a diagram of the grid pattern of the design and coordinates traveled by of an embodiment of the automated painting system.

FIG. 7 shows a top planar view of an alternate travel path and design painted onto a surface by an embodiment of the automated painting system.

### DETAILED DESCRIPTION OF THE INVENTION

Reference is made herein to the attached drawings. For the purposes of presenting a brief and clear description of the present invention, the preferred embodiment will be discussed as used for rapidly and efficiently painting designs on roadways, parking lots, and the like while avoiding reverse travel over wet paint of the newly painted areas. The figures are intended for representative purposes only and should not be considered to be limiting in any respect.

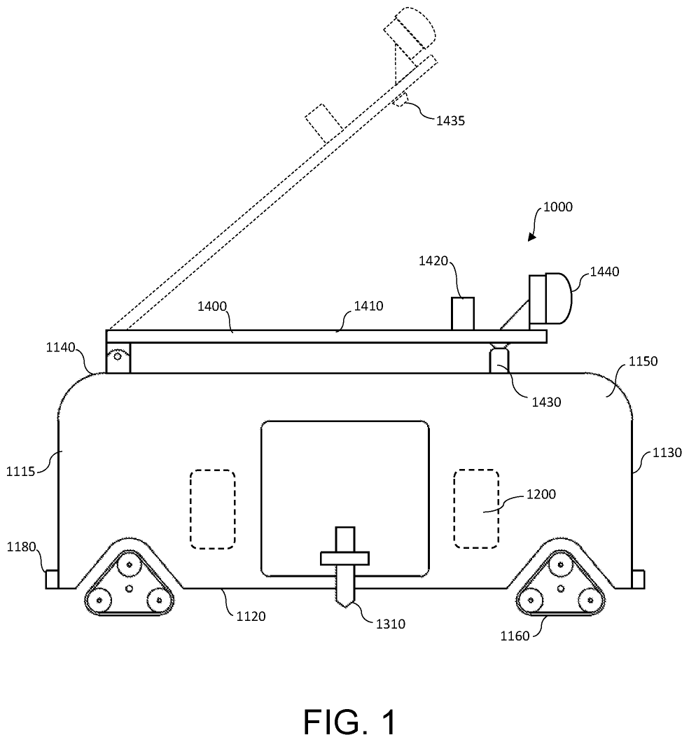

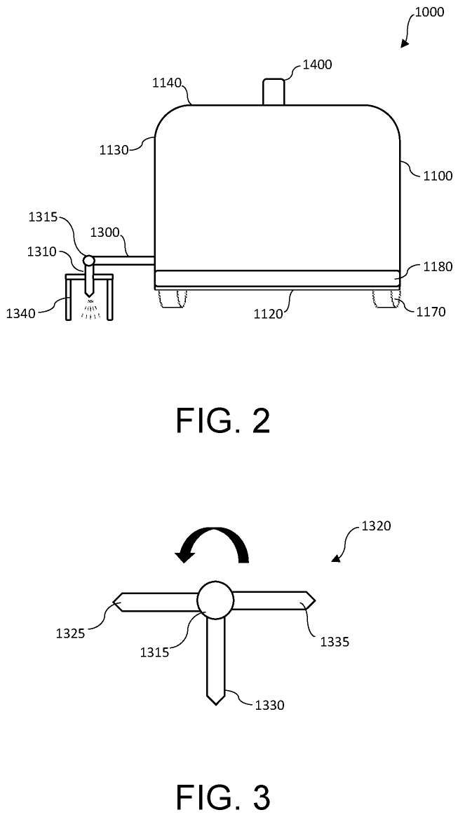

Referring now to FIGS. 1 and 2, there is shown a side view of an embodiment of the automated painting system and a front view of an alternate embodiment of the automated painting system, respectively. The automated painting system 1000 comprises a housing 1100 having at least one compartment 1200 for holding paint, wherein the housing 1100 is transportable via a driving system configured to propel the housing 1100 in a forward, backward, and lateral direction. A spraying mechanism is operably connected to the compartment 1200, wherein the spraying mechanism comprises an arm 1300 and spray head 1310 configured to move about a plurality of axes for painting designs onto surfaces, such as roadways, parking lots, and the like.

The housing 1100 is enclosed by a base 1120, a sidewall 1130, and a closed upper end 1140. In the illustrated embodiment, the housing 1100 is void of any windows or transparent material because an individual is not needed within the housing 1100 for operation. The automated painting system is configured to be operated remotely, automatically, or autonomously. In the illustrated embodiment, the housing 1100 comprises a rigid material, such as metal or hard plastic, configured to withstand impact from passing debris and protect the interior components. In the illustrated embodiment, the housing comprises a substantially rectangular shaped cross section. However, in alternate embodiments, the housing comprises any suitable cross section shape, such as any quadrilateral, ellipse, or irregular shape. The housing 1100 comprises rounded corners 1150 to prevent or reduce damage in the event of impact with another object. A front and rear bumper 1180 are disposed along the housing 1100 to further prevent damage thereto in the event of a collision with another object. Each bumper 1180 is elongated to cover a substantial width of the housing and composed of an absorbent material, such as rubber. In alternate embodiments, bumpers are disposed along the lateral sides of the housing. In the illustrated embodiment, the housing 1100 comprises a length between 7.5 to 8.5 feet, a width between 3.5 to 4.5 feet and a height between 3.5 to 4.5 feet, wherein the length is measured between the front and rear end of the housing, the width is measured between the lateral sides of the housing and the height is measured between the base and upper end of the housing. In the illustrated embodiment, the housing is large enough to be visible to oncoming traffic, unlike a smaller robotic device which can be easily ran over or crushed by a vehicle. The housing is sized to fit within a trailer that can be towed behind a passenger vehicle. The weight of the housing is configured such that it can be easily loaded and unloaded from the trailer. However, in alternate embodiments, the housing comprises other suitable size configured to easily transport paint and remotely paint designs on a surface.

In some embodiments, such as shown in FIG. 1, the driving system comprises a plurality of tracks 1160 extending from the base 1120 of the housing 1100, whereas in other embodiments, such as seen in FIG. 2, the driving system is movable via a plurality of wheels 1170 disposed along the base 1120 of the housing 1100. In the illustrated embodiment, the driving system comprises 4 independent drive assemblies and steering assembly to allow the housing 1100 to move in a crab walk configuration. This allows the housing 1100 to move on uneven surfaces while executing the painting of a design on the surface.

In some embodiments, the automated painting system 1000 comprises a light bar 1400 pivotally connected to the housing 1100. The light bar 1400 comprises an elongated bar 1410 that is rotatable about a hinged connection at the rear end 1115 of the housing 1100. A light 1420 is disposed on the bar 1410 and configured to illuminate the surrounding area to allow passing vehicles and pedestrians see the automated painting system when in use. This also allows the system 1000 to operate at night when visibility is low and there is less traffic. The bar 1410 rests on a mount 1430 when in a lowered or horizontal position. The mount 1430 comprises a projection extending from the upper end of the housing 1100 and receives a mating projection 1435 extending from the bar 1410. In alternate embodiments, additional lights are disposed on the front side and rear side of the housing, similar to the placement of front and rear lights of a vehicle, wherein the lights are configured to flash to warn approaching vehicles of that the automated painting system is in use. In the illustrated embodiment, the light bar 1400 further comprises a global positioning system (GPS) transmitter 1440 or transceiver that enables the automated painting system to send and receive location information.

The arm 1300 of the spraying mechanism extends from a lateral side of the housing 1100 and is configured to move in and out from the housing, as well as side to side between the front and rear ends of the housing. The arm is further configured to move up and down between the base and upper end of the housing 1100 to position spray head and nozzle at correct height from the surface to be painted. In alternate embodiments the arm is pivotally secured to the housing and can be rotated to a stored configuration, wherein the arm is parallel with a lateral side of the housing. In the illustrated embodiment, the arm 1300 comprises a rigid member having a first end connected to the housing and a second end pivotally connected to the spray head 1310 by a pivot member 1315. In the illustrated embodiment, the pivot member 1315 is a ball joint that allows the spray head 1310 to rotate 360 degrees and along a plurality of axes. In some embodiments, the pivot member 1315 is removably secured to the arm 1300 to allow the spray head 1310 to interchange with a second spray head.

In some embodiments, the spray head 1310 includes a single nozzle that dispenses a single color of paint from a compartment. This is beneficial when painting white markings of a roadway. However, in alternate embodiments, the spray head 1310 having a single nozzle is interchangeable with a spray head 1320 having multiple nozzles, such as shown in FIG. 3. In this way, a first nozzle 1325 is operably connected to a first compartment, a second nozzle 1330 is operably connected to a second compartment, and a third nozzle 1335 is operably connected to a third compartment, wherein each compartment comprises a different colored paint. Each nozzle is connected to a respective compartment via a hose. In alternate embodiments, 2 or more than 3 nozzles are disposed on a spray head. The pivot member 1315 allows for each nozzle to be rotated to an in-use position for dispensing paint onto a surface.

In the illustrated embodiment, shown in FIG. 2, the spraying mechanism further comprises a spray shield 1340 configured to surround the spray head 1310 on opposing sides to allow line width control and prevent paint from being sprayed passed a side of the spray shield. In some embodiments, the spray shield 1340 is disposed only on a single side of the spray head, whereas on alternate embodiments, the spray shield extends around adjacent sides or all the sides surrounding the spray head. The spray shield is also adapted to adjust in distance from the spray head to allow customizable line width. The adjustment fastener on the spray shield comprises any suitable mechanism such as a track that secures each side of the spray shield to one another. The spray shield is composed of any suitable material configured to prevent liquid from passing therethrough. In some embodiments, the spray shield comprises a plastic material that is easily cleaned when the automated painting system is not in use. In some embodiments, the spray shield is removably attached to an individual spray head or directly to the arm. In some embodiments, an attachment is removably securable to the nozzle to provide for an over spray effect, as desired by the user.

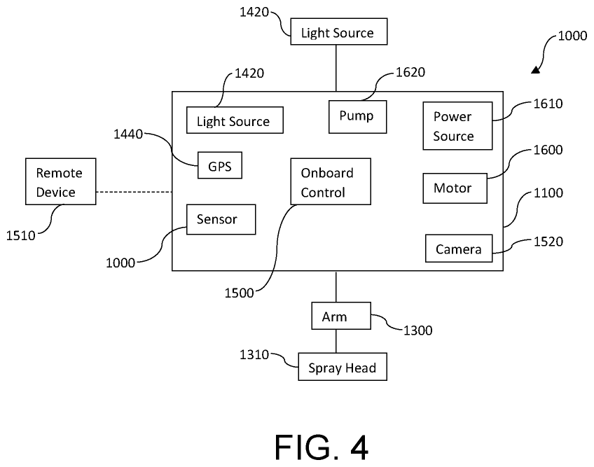

Referring now to FIG. 4, there is shown a block diagram of an embodiment of the automated painting system. The automated painting system 1000 comprises an onboard control 1500 having a logic that is operably connected to the electrical components of the system and receives commands that when executed by a processor of the onboard control causes the movement and operation of the components of the system 1000. The GPS 1440 and lights 1420, both on the light bar and on the housing, are operably connected to and controlled by the onboard control. The onboard control turns the lights on and off and receives location information from the GPS and is adapted to send location information to a remote device 1510. The remote device 1510 is a separate electronic device such as a computer or mobile device having a display screen adapted to send and receive information to the onboard control 1500. In one embodiment, the GPS is operable connected to the drive system, such that a user may reposition the automated painting system 1000 by selecting GPS coordinates. When selected, the automated painting system 1000 may travel to that location. In operation, the automated painting system 1000 is positioned close to the initial GPS coordinate, such that the selected GPS coordinate function as a home position or calibration from which the grid is based therefrom.

In some embodiments, one or more cameras 1520 are mounted on the housing 1100 to allow a user having access to the remote device can monitor the operation of the system 1000 and provide commands to the onboard control 1500 remotely. For example, the entire painting of a design can be performed automatically via preprogrammed instructions received by the onboard control 1500. Alternatively, an operator can remotely provide instructions to the onboard control 1500 via the remote device. In one embodiment, a user may place a starting marker at a home position, wherein the camera 1520 is adapted to detect. The starting marker acts as the home position from which the grid is based thereon. The onboard control 1500 further provides operation of the painting by controlling the solenoid valves to release paint from each compartment to the nozzle, operate a pump for the paint release 1620, and control the movement of the arm 1300 and pivot member of the spray head 1310.

In some embodiments, one or more proximity sensors are disposed on the housing 1100. The sensors are configured to detect if another object is within a predetermined distance. This way, the system 1000 is configured to detect if an object is within a spray path and can avoid spraying or moving if instructed. In other embodiments, other types of sensors are disposed on or around the housing such as temperature sensors. In this way, the system 1000 can detect a temperature that may be too hot or too cold for painting a surface.

In the illustrated embodiment, the GPS operates in conjunction with geometry code programs and custom control language received by the onboard control to instruct the specific directional movement of the arm, nozzle, and housing. In the illustrated embodiment, the arm is operated by a computerized numerical control (CNC) for motion control of the spray pattern.

In some embodiments, the driving system comprises a motor 1600, such as a DC servomotor configured to control the movement of the wheels or tracks. The motor 1600 is also connected to the onboard control 1500 for instructing the movement of the housing via the driving system. In some embodiments, a secondary power source 1610 is operably connected to the onboard control 1500 to power the other components of the housing 1100. In some embodiments, the power source 1610 includes a DC operated rechargeable battery, whereas in other embodiments, the power source is a generator that is fuel operated.

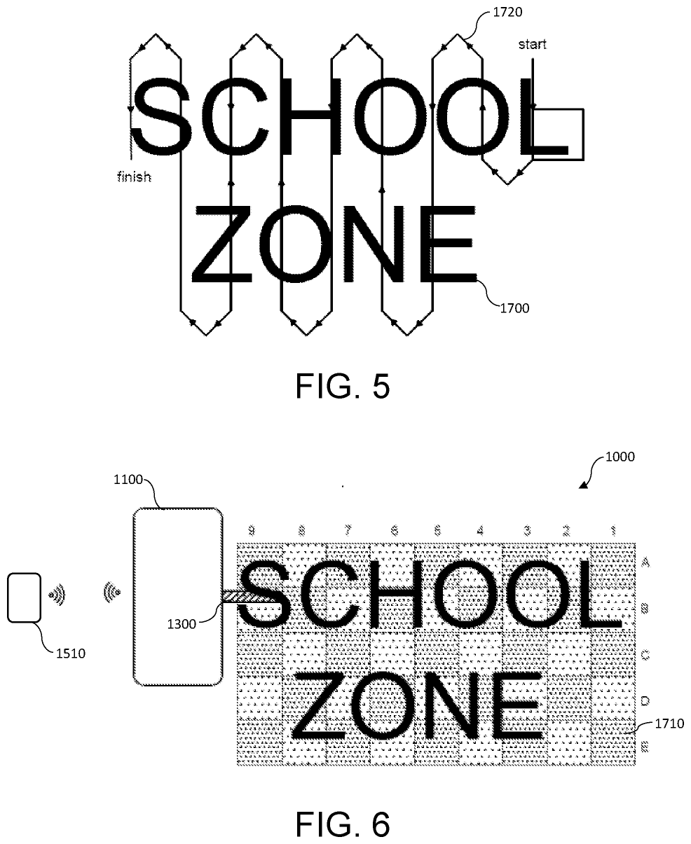

Referring now to FIGS. 5 and 6, there is shown a top planar view of a travel path and design painted onto a surface by an embodiment of the automated painting system and a diagram of the grid pattern of the design and coordinates traveled by of an embodiment of the automated painting system, respectively. A programmed design 1700 is communicated to the onboard control as a grid pattern having a series of uniform blocks 1710 aligned in rows and columns. The onboard control paints the design onto the surface by causing the arm 1300 and housing 1100 to move along the grid pattern to avoid the housing 1100 moving through wet paint. In the illustrated embodiment, the arm 1300 is configured to deliver a spray path 1720 of 24 inches wide and 24 inches long before advancing to the next block 1710. In the illustrated embodiment, each block 1710 is 24 inches wide and 24 inches long, whereas in alternate embodiments, the spray path and corresponding blocks of the grid pattern are sized relative to each preprogrammed design and changeable according to a design size/pattern needed. The housing will move, after each line (row or column) within the grid pattern is complete, to a parallel offset position and start a second line (row or column, respectively) of the design within the grid pattern. The cycle is then repeated on an adjacent block. The described directional movement of the housing and arm in the grid pattern is the most efficient way to allow the housing to move while avoiding having the housing 1100 pass through any wet paint.

For example, the onboard control instructs the housing to into position on block A1. The arm 1300 is then configured to move along the X and Y axes to paint over the 24 inch×24 inch block 1710, spraying areas indicated by the design. Once this is complete, the onboard control instructs the housing 1100 to advance to the next block 1710, wherein the arm and spray head execute the movements for painting the design. When the housing 1100 reaches the end of each column, the housing is moved to a parallel offset position to start a second column of the design and repeats increments in the reverse direction, to complete another set of row blocks. The movement and execution of instructions are continued until the spray path reaches the last block 1710, which is B9 in the shown example.

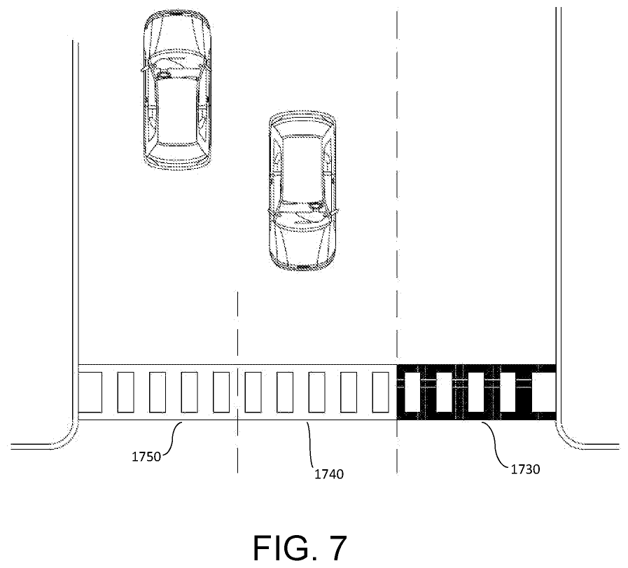

In some embodiments, the onboard control is configured to receive a preprogrammed design that is separated into multiple sections or grid patterns, such as shown in FIG. 7. This allows a design, such as a cross walk, to be painted on a roadway without having to close off traffic of the entire road. The automated painting system 1000 is configured to paint a first grid pattern 1730, then once the design on the first grid pattern is complete move onto a second grid pattern 1740, and then a third grid pattern 1750, wherein each grid pattern is allowed time to dry before moving onto the next grid pattern and opening up the flow of traffic over the grid patterns. This allows for the continuous flow of traffic flowing by only having the system execute one section or grid pattern at a time and then moving on to another section.

A design herein refers to any markings, logo, pattern, signage, and the like to be painted on a surface. A design can be as simple as a line on the road or as complex as a detailed company logo with multiple colors to be painted on a parking lot surface. A design can be preprogrammed and downloadable directly to the onboard control or can be received directly by the onboard control and stored for future painting applications. In some embodiments, the onboard control comprises a memory configured to store a plurality of different designs, wherein each design can be marked with a location tag.

In operation, the housing will start at pre-determined position that can be marked by indicia, such as a brass insert on the surface to be painted. The onboard control having logic, when executed by a processor causes the arm to be housing and the arm to be moved along the grid pattern such that the design within a first block of the array is painted first. In the illustrated embodiment, when the housing has advanced to a block, only the arm and spray head move to complete the painting of the block. The housing does not move of advance to a next block until the painting of the block is completed. The housing is then repositioned to a parallel offset location of the grid pattern once each line of blocks has been painted. The spray head and nozzle will stop and start as instructions are delivered by the onboard control. In the illustrated embodiment, the arm is controlled by G-code programming and allows for paint to be dispersed at least 4 times faster than by a skilled worker person. The configuration of the driving system, the housing, spraying mechanism, and onboard control allows for painting of designs between curbs, barriers, and walls, and well as other 3D objects. The automated painting system is configured to paint by forward and reverse action when moving through the grid pattern. The 4-axis movement of the spray nozzle arm will allow for 3D painting of concrete curbs and rounded speed bumps.

The present invention allows for the automated painting of markings onto a city roadway, private streets, parking lots, and the like where traffic is a safety risk to workers. It allows for operation thereof with minimal human assistance, and remote operation if needed from as safe distance from traffic. The need for physical design templates to be placed on a surface is also eliminated. Additionally, once an area or complete city has been mapped, then year after year re-painting can be done much faster, accurate and efficient than having an individual repaint a surface.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. An automated painting system for painting a design onto a surface, comprising:
a housing having a compartment for holding paint;
a spraying mechanism operably connected to the compartment, wherein the spraying mechanism comprises a spray head configured to move about a plurality of axes for painting the three dimensional objects;
wherein the spraying mechanism is adapted to spray paint within a spray area;
an arm extending from a side of the housing connected to the spraying mechanism to provide motion control for the spray head;
a driving system configured to propel the housing;
a global positioning system (GPS) operably connected to an onboard control for determining the position of the housing, wherein the driving system is adapted to cause the housing to travel to a location;
wherein the onboard control having logic, that when executed by a processor causes the following;
receiving an input of the design;
mapping the design to a design area comprising an array of blocks arranged in a row and column, wherein the blocks correspond to the spray area of the spray head;
positioning the housing, via the driving system, such that the spray head is positioned within a first block of the spray area;
moving the arm to control the spray head within the first block to spray paint associated with the design corresponding to the first block;
repositioning the housing to an adjacent block and spraying paint associated with the second block;
repeating the movement of the housing, arm, and spray head until the design is completed.

2. The automated painting system of claim 1, further comprising a servomotor operably connected to the driving system to drive the housing.

3. The automated painting system of claim 1, further comprising a power source to operate the arm, GPS, and spraying mechanism of the housing.

4. The automated painting system of claim 3, wherein the power source is a rechargeable battery.

5. The automated painting system of claim 3, wherein the power source is a generator configured to operate on a fuel source.

6. The automated painting system of claim 1, further comprising a light bar pivotally connected to the housing, wherein the light bar comprises at least one light configured to illuminate a surrounding area of the housing.

7. The automated painting system of claim 6, wherein the light bar is pivotally secured to a rear side of an upper end of the housing and is entirely disposed above the housing.

8. The automated painting system of claim 6, wherein the light bar comprises a GPS transmitter dome at a distal end thereof.

9. The automated painting system of claim 1, wherein the spraying mechanism further comprises a spray shield configured to enclose the spray head to prevent paint from being sprayed passed a side of the spray shield.

10. The automated painting system of claim 9, wherein the spray shield comprises a pair of opposing planar members adjustably secured around the spray head.

11. The automated painting system of claim 1, wherein the onboard control is configured to receive a predesigned pattern and execute the predesigned pattern via instructing the spraying mechanism.

12. The automated painting system of claim 1, further comprising a second compartment configured to hold a second color paint, wherein the second compartment is operable connected to the spraying mechanism.

13. The automated painting system of claim 1, further comprising lights disposed on the front side and rear side of the housing, wherein the lights are configured to flash.

14. The automated painting system of claim 1, wherein the spraying mechanism is adapted to spray paint in various orientations for the painting of three-dimensional design.

15. The automated painting system of claim 1, wherein the driving system comprises a plurality of wheels extending from a base of the housing.

16. The automated painting system of claim 1, wherein the driving system comprises a plurality of tracks extending from a base of the housing.

17. The automated painting system of claim 1, further comprising a camera mounted to the housing wherein the camera is operably connected to a remote electronic device for monitoring activity around the housing.

18. The automated painting system of claim 1, wherein the driving system comprises four independent drive assemblies and steering assembly to allow the housing to move in a crab walk configuration.

19. The automated painting system of claim 1, wherein the spray head is pivotally secured to the arm via a ball joint.

20. The automated painting system of claim 19, wherein the spray head comprises a plurality of nozzles, wherein each nozzle is operably connected to a distinct compartment having a different color of paint in each compartment.
